(19) United States
(12) Patent Application Publication
(10) Pub. No.: US 2026/0006031 A1
(43) Pub. Date: Jan. 1, 2026

(54) EFFICACY SCORING METRIC FOR AN ACCESS CONTROL POLICY LIST

(71) Applicant: Fortinet, Inc., Sunnyvale, CA (US)

(72) Inventors: Rajiv Sreedhar, Sunnyvale, CA (US); Damodar Krishna Hegde, Santa Clara, CA (US)

(73) Assignee: Fortinet, Inc., Sunnyvale, CA (US)

(21) Appl. No.: 18/920,701

(22) Filed: Oct. 18, 2024

Related U.S. Application Data
(63) Continuation-in-part of application No. 18/759,976, filed on Jun. 30, 2024, now abandoned.

(51) Int. Cl. H04L 9/40

(52) U.S. Cl. CPC H04L 63/101; H04L 63/20

(57) ABSTRACT

An ZTNA efficacy score representing a combination of ZTNA rule accuracy and ZTNA rule manageability is periodically determined. The ZNTA rule accuracy is scored based on allowed legitimate flows and blocked illegitimate flows in relation to allowed illegitimate flows and blocked legitimate flows. The ZNTA rule manageability is scored based on a volume of the ZTNA rules. Responsive to the ZNTA efficacy score, the ZTNA efficacy score is raised by automatically adjusting the ZTNA rules, using machine learning, to maximize ZTNA rule accuracy and ZTNA rule manageability by reducing false positives and false negatives and by reducing the number of rules. The updated ZTNA rule set can be applied to real-time traffic.

### RELATED APPLICATIONS

This application is a continuation-in-part of U.S. application Ser. No. 18/759,976, filed on Jun. 30, 2024, which is incorporated herein by reference in its entirety.

### FIELD OF THE INVENTION

The invention relates generally to computer networks, and more specifically, for an efficacy scoring metric for an access control policy list in Zero Trust Network Access (ZTNA).

### BACKGROUND

Access control policy lists (ACLs) restrict unwanted potentially malicious communication between network devices. The optimal specification of ACLs has become very important for implementing Zero Trust Network Access (ZTNA) security for corporate enterprise networks. Given two access control policy lists currently there is no measure or scoring metric to compare them determine how good they are from the point of view of providing ZTNA. Additionally, there may be cases where the two access control lists provide the same security from the point of ZTNA but one of them may be much more complex than the other. As an example, one may have more access control policies than the other or one may have more complex source or destination group specifications. In general, simpler (fewer access control policy rules) are better than more complex (more access control policy rules) ACLs because it is easier from the viewpoint of manageability. Currently there is no systematic scoring method to compare two ACLs from the point of view of both ZTNA security efficacy and manageability.

What is needed is a robust technique for an efficacy scoring metric for an access control policy list in ZTNA.

### SUMMARY

To meet the above-described needs, methods, computer program products, and systems for an efficacy scoring metric for an access control policy list in ZTNA.

In one embodiment, a set of ZTNA access control policies is generated for automatically securing the network. The set of ZTNA access control policies is applied against different sessions in real-time traffic of the network, to identify allowed sessions and blocked sessions. A false positive or a false negative is detected from the allowed and blocked sessions from application of ZTNA rules, wherein the false positive comprises a blocked legitimate flow and the false negative comprises an allowed illegitimate flow.

In another embodiment, an ZTNA efficacy score representing a combination of ZTNA rule accuracy and ZTNA rule manageability is periodically determined. In one case, the ZNTA rule accuracy is scored based on allowed legitimate flows and blocked illegitimate flows in relation to allowed illegitimate flows and blocked legitimate flows. The ZNTA rule manageability is scored based on a volume of the ZTNA rules.

In yet another embodiment, responsive to the ZNTA efficacy score, the ZTNA efficacy score is raised by automatically adjusting the ZTNA rules, using machine learning, to maximize ZTNA rule accuracy and ZTNA rule manageability by reducing false positives and false negatives and by reducing the number of rules. The updated ZTNA rule set can be applied to real-time traffic.

Advantageously, computer hardware performance and computer network performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for an efficacy scoring metric for an access control policy list in ZTNA, according to some embodiments.

FIG. 2 is a more detailed block diagram illustrating a ZTNA server of the system of FIG. 1, according to an embodiment.

FIGS. 3A-3C is a more detailed block diagram illustrating legitimate and illegitimate flows of the system of FIG. 1, according to an embodiment.

FIGS. 3D and 3E illustrate web server communication, according to some embodiments.

FIG. 4 is a high-level flow diagram illustrating a method for network security using ZTNA, according to an embodiment.

FIG. 5 is a flow diagram illustrating a step for an efficacy scoring metric for an access control policy list in ZTNA, from the method of FIG. 5, according to an embodiment.

FIG. 6 is a block diagram illustrating an example computing device for the system of FIG. 1, according to an embodiment.

### DETAILED DESCRIPTION

Methods, computer program products, and systems for an efficacy scoring metric for an access control policy list in ZTNA. The following disclosure is limited only for the purpose of conciseness, as one of ordinary skill in the art will recognize additional embodiments given the ones described herein.

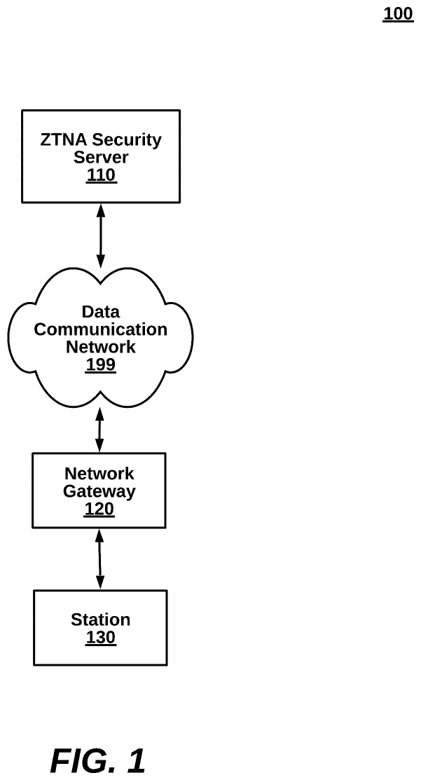

### I. Systems for Access Control List Efficacy Scoring (FIGS. 1-3)

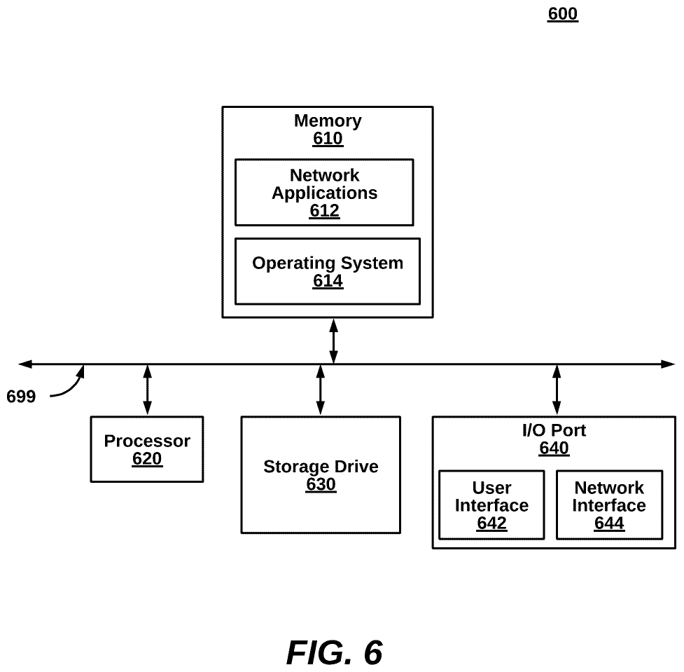

FIG. 1 is a high-level block diagram illustrating a system 100 for an efficacy scoring metric for an access control policy list in ZTNA, according to an embodiment. The system 100 includes a ZTNA server 110, a network gateway 120, and a station 130, on a data communication network. Other embodiments of the system 100 can include additional components that are not shown in FIG. 1, such as routers, switches, network gateways, and firewalls, and access points. The components of system 100 can be implemented in hardware, software, or a combination of both. An example implementation is shown in FIG. 6.

In one embodiment, the components of the system 100 are coupled in communication over a private network connected to a public network, such as the Internet. In another embodiment, system 100 is an isolated, private network, or alternatively, a set of geographically dispersed LANs. The components can be connected to the data communication system via hard wire (e.g., ZTNA security server 110, network gateway 120, and station 130). The components can also be connected via wireless networking (e.g., station 130). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

In one embodiment, the ZTNA server 110 prepares trusted users of an enterprise network for phishing e-mails. A machine learning model is established by monitoring user behavior for known phishing e-mails. A new campaign is initiated when a unique phishing e-mail is identified. The new campaign can customize a set of phishing e-mails to trusted users, based on individualized user behavior. Individual responses to the e-mails are monitored and used to generate a custom training video for each user.

The user devices 140A-C can be a personal computer, a laptop, a smartphone, a tablet, a terminal, or any other appropriate processor-driven device for e-mail services. An e-mail client is a user application, such as a web browser, Outlook, or the like can retrieve and display e-mail from the e-mail server 120. Users can compose new e-mails, retrieve stored e-mails, and forward and reply to stored e-mails.

In a network there are legitimate flows (or connections) that need to be allowed and potentially malicious flows that need to be blocked. An access control policy list (ACL) consisting of an ordered set of an ordered set of access control rules is used to secure the network, ideally this ACL should facilitate application availability by allowing necessary flows while blocking unnecessary flows based on the principle of ZTNA.

In a computer network, the set of all possible flows or the Universe of flows {U} consists of the union of Legitimate flows {L} and unnecessary or Illegitimate flows. This is written as

$$U = L ⋃ I$$

A flow can either be legitimate or illegitimate but not both. This is represented by

$$L ⋂ I = ∅$$

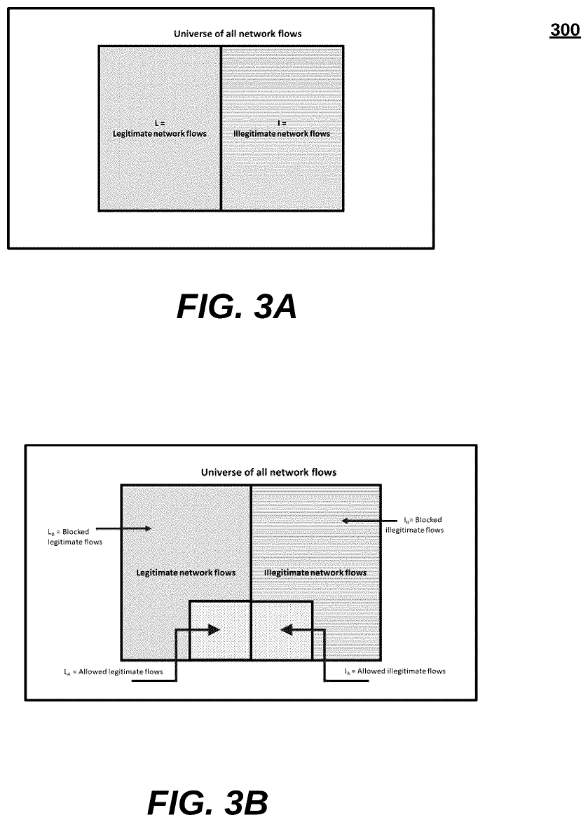

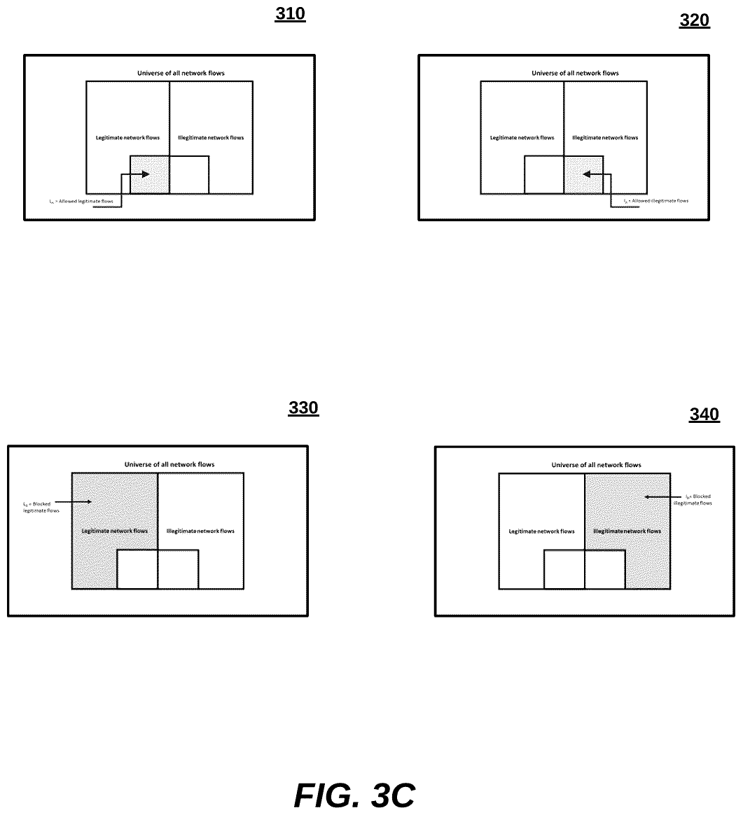

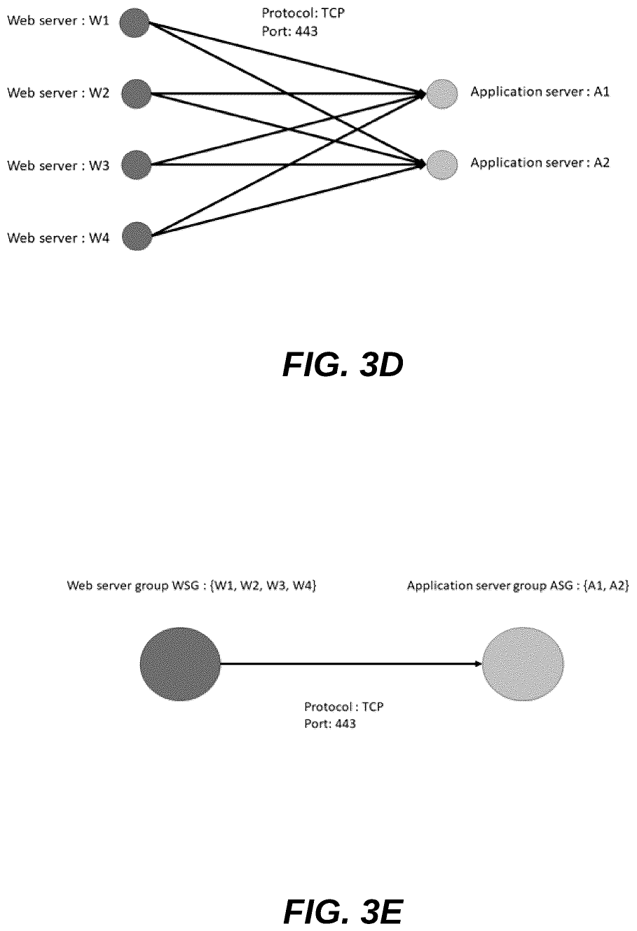

and shown in FIG. 3A.

When an access control policy list is applied the flows in {U} may either be permitted by the access control policy list or blocked by the access control policy list. The universe of flows under the influence of the access control policy can be represented as shown in FIG. 3B.

Any flow in the universe of flows can be classified into one of allowed legitimate flows 310, allowed illegitimate flows 320, blocked legitimate flows 330 and blocked legitimate flows 340, as shown in FIG. 3C.

Ideally a good ACL should minimize blocked legitimate flows and allowed illegitimate flows. This is equivalent to maximizing allowed legitimate flows and blocked illegitimate flows. Only the legitimate flows can be expressed as

$$L = {L}_{allowed} + {L}_{blocked}$$

Only the illegitimate flows can be expressed as

$$I = {I}_{allowed} + {I}_{blocked}$$

The ZTNA precision of the access control policy list, in an embodiment, is the percentage of allowed flows that are legitimate, and can be expressed as

$${ZTNA}_{precision} = \frac{{L}_{allowed}}{{L}_{allowed} + {I}_{allowed}}$$

The ZTNA precision of the ACLs is a measure of zero trust. If ZTNA precision is equal to 1 there are no illegitimate flows allowed.
The ZTNA recall of the ACL is the percentage of legitimate flows that are correctly allowed can be expressed as

$${ZTNA}_{recall} = \frac{{L}_{allowed}}{{L}_{allowed} + {L}_{blocked}}$$

The ZTNA recall is a measure of network or service availability since any legitimate flows that are blocked affects the availability of the network or service.

The best ACL rules are rules that are highly available and have the best ZTNA characteristics. If the ZTNA_{precision} and ZTNA_{recall} are equally important, then the ZTNA_{F1} score can be defined as

$${ZTNA}_{F 1} = \frac{{ZTNA}_{precision} * {ZTNA}_{recall}}{{ZTNA}_{precision} + {ZTNA}_{recall}}$$

The ZTNA_{F1} score, in an embodiment, ranges between 0 and 1, with 0 being the worst and 1 being the best. Many other variations and formula modifications are possible.

The complexity of the ACL rule set is the second aspect of comparing two or more ACL sets with the same blocking characteristics (ie. they have the same ZTNA_{F1} score). A flow blocked by one ACL rule set is also blocked by the second ACL ruleset and a flow allowed by one ACL rule set is also allowed by the second ACL ruleset. Though the blocking characteristic of the two ACL rules sets are identical, one is better than the other from the point of view of complexity.

The ACL rule set can be considered as a graph with the nodes (or vertices) of the graph consisting of the sources and destinations of the flows and the links (edges) of the graph representing the blocked or allowed flows with the link properties defining the characteristic of the flows that are allowed or blocked. The complexity of the graph representing the ACL ruleset can be captured by number of nodes (or vertices) and the number of edges (or links). From a manageability standpoint a low complexity ACL policy set is better than a high complexity ACL policy set.

Consider the following scenario of the Web servers communicating with the Application servers, shown in FIG. 3D. The access control policy can enable web servers W1, W2, W3, and W4 to communicate with application servers A1, and A2. The communication uses the TCP protocol over port 443.

The resulting access control policies are shown in Table 1. The communication between the two groups is shown in FIG. 3E.

The access control polices for the communication shown in are shown in Table 2. The fine grained polices consist of 8 polices entries while the concise policy definition consists of one entry.

TABLE 2
Concise or resilient access control polices.

| # | Source | Destination | Protocol | Destination Port | Action |
|---|---|---|---|---|---|
| 1 | WSG | ASG | TCP | 443 | Allow |

To compare the complexity a manageability factor (ρm) can be defined. Consider an access control policy ruleset where the number of rules is Nᵣ. The manageability index ρm of that ruleset can be defined as

$${ρ}_{m} = \frac{{N}_{f} - {N}_{r}}{{N}_{f}}$$

Where N_{f} is defined as the number rules in the fine-grained ruleset. The manageability factor ρm has a lower bound of 0 and an upper bound of 1. So, for the example shown in Table 1 and Table 2 the value of N_{f} is 8 and the value of
Nᵣ is 1. The manageability index for this example is

$${ρ}_{m} = \frac{8 - 1}{8} = 0.875$$

A goodness score of access control policies (G_{ACL}) can be defined byu combining the ZTNA_{F1} score and the manageability factor ρₘ as follows

$${G}_{ACL} = {ρ}_{m} \cdot {ZTNA}_{F 1}$$

This score is close to 0 for access control policies with either bad ZTNA characteristics or bad manageability characteristics, and a number close to 1 for concise access control policies that have very good ZTNA characteristics. The goodness score is a score that captures both security (ZTNA) and manageability aspects of a single score that can be used to compare any 2 sets of access control policies.

This goodness score can be used for continuously monitoring the quality of the access control polices and provide a definitive measure for quantifying ACL policy improvements.

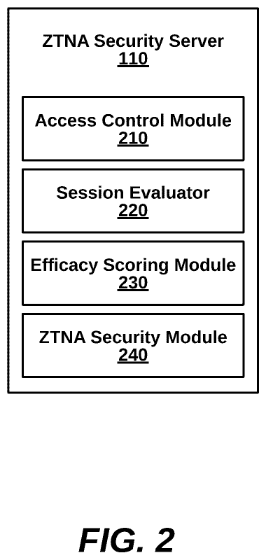

FIG. 2 is a more detailed block diagram illustrating the ZTNA 110 of the system of FIG. 1, according to one embodiment. The phishing e-mail database 110 includes an access control module 210, a session evaluator 220, an efficacy scoring module 230, and a ZTNA security module 240. The components can be implemented in hardware, software, or a combination of both.

The access control module 210 generating a set of ZTNA access control policies for automatically securing the network;

The session evaluator applies the set of ZTNA access control policies against different sessions in real-time traffic of the network, to identify allowed sessions and blocked sessions.

The efficacy scoring module 230 detects a false positive or a false negative from the allowed and blocked sessions from application of ZTNA rules. The false positive comprises a blocked legitimate flow and the false negative comprises an allowed illegitimate flow. The efficacy scoring module 230 periodically determines an ZTNA efficacy score representing a combination of ZTNA rule accuracy and ZTNA rule manageability. IN more detail, the ZNTA rule accuracy is scored based on allowed legitimate flows and blocked illegitimate flows in relation to allowed illegitimate flows and blocked legitimate flows. The ZNTA rule manageability is scored based on a volume of the ZTNA rules. Responsive to the ZNTA efficacy score, the ZTNA efficacy score is raised by automatically adjusting the ZTNA rules, using machine learning, to maximize ZTNA rule accuracy and ZTNA rule manageability by reducing false positives and false negatives and by reducing the number of rules.

The ZTNA security module 240 implements updated ZTNA rule set to real-timecan build a machine learning recognition model from a history of images associating the identified person.

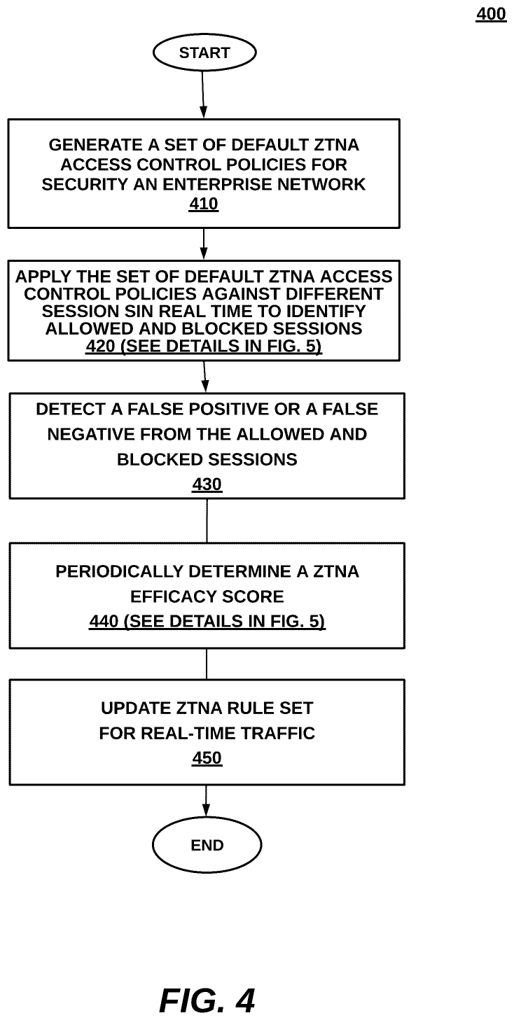

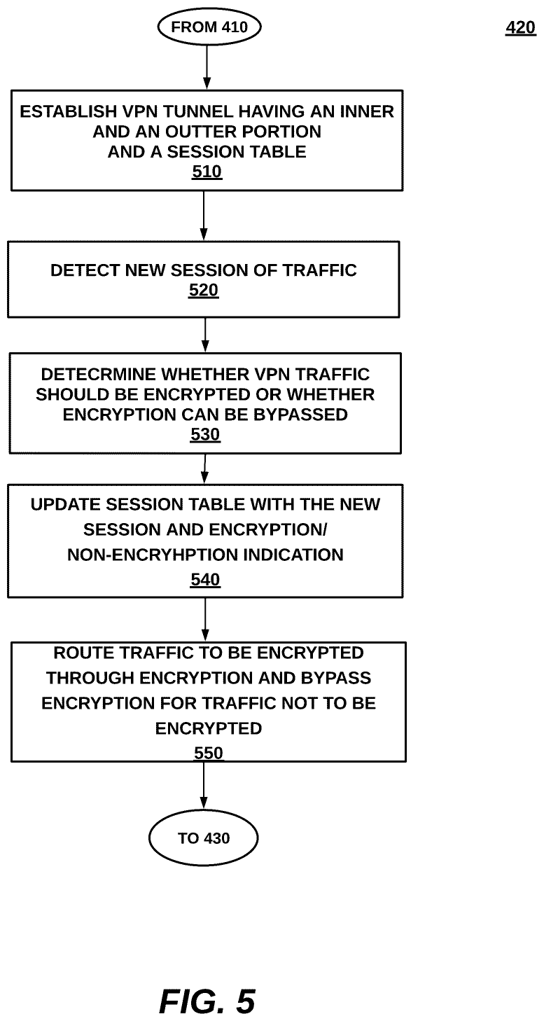

### II. Methods for Access Control List Efficacy Scoring (FIGS. 4-5)

FIG. 4 is a high-level flow diagram of a method 400 for network security using ZTNA, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, a set of ZTNA access control policies is generated for automatically securing the network.

At step 420, the set of ZTNA access control policies is applied against different sessions in real-time traffic of the network, to identify allowed sessions and blocked sessions.

At step 430, a false positive or a false negative is detected from the allowed and blocked sessions from application of ZTNA rules. The false positive comprises a blocked legitimate flow and the false negative comprises an allowed illegitimate flow.

At step 440, an ZTNA efficacy score representing a combination of ZTNA rule accuracy and ZTNA rule manageability is periodically determined, as shown in FIG. 5. In more detail, at step 510, the ZNTA rule accuracy is scored based on allowed legitimate flows and blocked illegitimate flows in relation to allowed illegitimate flows and blocked legitimate flows. At step 520, the the ZNTA rule manageability is scored based on a volume of the ZTNA rules. At 530, responsive to the ZNTA efficacy score, the ZTNA efficacy score is raised by automatically adjusting the ZTNA rules, using machine learning, to maximize ZTNA rule accuracy and ZTNA rule manageability by reducing false positives and false negatives and by reducing the number of rules.

Referring again to FIG. 4, step 450, the updated ZTNA rule set is implemented to real-time data traffic.

### III. Computing Device for Access Control List Efficacy Scoring (FIG. 6)

FIG. 6 is a block diagram illustrating a computing device 600 for use in the system 100 of FIG. 1, according to one embodiment. The computing device 600 is a non-limiting example device for implementing each of the components of the system 100, including phishing testing server 110, e-mail server 120, and user devices 130A-C. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a network security device, on a data communication network, for an efficacy scoring metric for an access control policy list in Zero Trust Network Access (ZTNA), the method comprising:
generating a set of ZTNA access control policies for automatically securing the network;
applying the set of ZTNA access control policies against different sessions in real-time traffic of the network, to identify allowed sessions and blocked sessions;
detecting a false positive or a false negative from the allowed and blocked sessions from application of ZTNA rules, wherein the false positive comprises a blocked legitimate flow and the false negative comprises an allowed illegitimate flow;
periodically determining an ZTNA efficacy score representing a combination of ZTNA rule accuracy and ZTNA rule manageability, comprising:
scoring the ZNTA rule accuracy based on allowed legitimate flows and blocked illegitimate flows in relation to allowed illegitimate flows and blocked legitimate flows;
scoring the ZNTA rule manageability based on a volume of the ZTNA rules; and
responsive to the ZNTA efficacy score, raising the ZTNA efficacy score by automatically adjusting the ZTNA rules, using machine learning, to maximize ZTNA rule accuracy and ZTNA rule manageability by reducing false positives and false negatives and by reducing the number of rules; and
implementing updated ZTNA rule set to real-time.

2. A non-transitory computer-readable medium in a network security device, on a data communication network, storing code that when executed, performs a method for an efficacy scoring metric for an access control policy list in Zero Trust Network Access (ZTNA), the method comprising:
generating a set of ZTNA access control policies for automatically securing the network;
applying the set of ZTNA access control policies against different sessions in real-time traffic of the network, to identify allowed sessions and blocked sessions;
detecting a false positive or a false negative from the allowed and blocked sessions from application of ZTNA rules, wherein the false positive comprises a blocked legitimate flow and the false negative comprises an allowed illegitimate flow;
periodically determining an ZTNA efficacy score representing a combination of ZTNA rule accuracy and ZTNA rule manageability, comprising:
scoring the ZNTA rule accuracy based on allowed legitimate flows and blocked illegitimate flows in relation to allowed illegitimate flows and blocked legitimate flows;
scoring the ZNTA rule manageability based on a volume of the ZTNA rules; and
responsive to the ZNTA efficacy score, raising the ZTNA efficacy score by automatically adjusting the ZTNA rules, using machine learning, to maximize ZTNA rule accuracy and ZTNA rule manageability by reducing false positives and false negatives and by reducing the number of rules; and
implementing updated ZTNA rule set to real-time.

3. A network security device, on a data communication network, for an efficacy scoring metric for an access control policy list in Zero Trust Network Access (ZTNA), the network security device comprising:
a processor;
a network interface communicatively coupled to the processor and to a data communication network; and
a memory, communicatively coupled to the processor and storing:
a access control policy module to generate a set of ZTNA access control policies for automatically securing the network;
a session evaluator to apply the set of ZTNA access control policies against different sessions in real-time traffic of the network, to identify allowed sessions and blocked sessions.
an efficacy scoring module to detect a false positive or a false negative from the allowed and blocked sessions from application of ZTNA rules, wherein the false positive comprises a blocked legitimate flow and the false negative comprises an allowed illegitimate flow,
wherein the efficacy scoring module periodically determines an ZTNA efficacy score representing a combination of ZTNA rule accuracy and ZTNA rule manageability, comprising:
scoring the ZNTA rule accuracy based on allowed legitimate flows and blocked illegitimate flows in relation to allowed illegitimate flows and blocked legitimate flows;
scoring the ZNTA rule manageability based on a volume of the ZTNA rules,
wherein the efficacy scoring module, responsive to the ZNTA efficacy score, raises the ZTNA efficacy score by automatically adjusting the ZTNA rules, using machine learning, to maximize ZTNA rule accuracy and ZTNA rule manageability by reducing false positives and false negatives and by reducing the number of rules; and
a ZTNA rule module to implement an updated ZTNA rule set to real-time.
